(19) United States
(12) Patent Application Publication
(10) Pub. No.: US 2011/0119487 A1
(43) Pub. Date: May 19, 2011

(54) System and method for encryption rekeying

(75) Inventors: Peter Alexander, Woodbine, MD (US); James Sansing, Ellicott City, MD (US)

(73) Assignee: Velocite Systems, LLC, Glen Burnie, MD (US)

(21) Appl. No.: 12/925,080

(22) Filed: Oct. 13, 2010

Related U.S. Application Data
(60) Provisional application No. 61/261,089, filed on Nov. 13, 2009.

(51) Int. Cl. H04L 9/00

(52) U.S. Cl. 713/160

(57) ABSTRACT

Disclosed is a system and method for maintaining a secure, encrypted networking session across a communications network by dynamically replacing encryption keys during the networking session and without terminating the session. A secure control channel is embedded within the general encrypted network connection and is used to transport encrypted control messages from one network endpoint to another. In order to hide that fact that such control messages are being transferred (as opposed to general network data traffic), the control message data packets are formatted in a way to simulate the standard general network data packets.

### CROSS REFERENCE TO RELATED APPLICATION

This application is based upon and claims benefit of copending U.S. Provisional Patent Application Ser. No. 61/261,089 entitled “Encryption Rekeying Process”, filed with the U.S. Patent and Trademark Office on Nov. 13, 2009 by the inventors herein, the specification of which is incorporated herein by reference.

### FIELD OF THE INVENTION

The present invention relates generally to the field of secured communications in network systems, and more particularly to systems and methods for managing the distribution and use of encryption keys during networking sessions.

### BACKGROUND OF THE INVENTION

Computer network systems typically comprise a group of computers and other devices that are interconnected by communication channels that facilitate communications among users and allow users to share resources. Such networks may be used to facilitate communications among persons that are geographically dispersed, to allow persons to share commonly used hardware resources (e.g., printers), to share files and data, and to share software applications. Computer network systems are with increasing frequency being used to manage critical organization data in various forms, including video, audio, and graphical formats.

For many organizations, such data may be sensitive information that the organization wishes to protect from third party view. In order to protect such data as it is being transmitted across a computer network, computer network systems will often employ a private link, the most common form of which is typically referred to as a Virtual Private Network, or “VPN.” Although there are other types of such private links (e.g., direct point-to-point), the remainder of this document shall use the term “VPN” to refer to all such private links. A VPN is a private network that uses a public network (usually the Internet) to connect remote sites or users together, using “virtual” connections routed through the Internet from one network system data point (e.g., a company's private network) to another network system data point (e.g., a remote site or remote employee).

As data is transmitted across the VPN, several methods may be used to keep both the network connection and the data being transmitted secure, including encryption. Encryption is carried out through the use of encryption keys that are established between each end point of a network connection. Those encryption keys need to be replaced periodically to ensure that the VPN remains secure. Typically, in order to replace encryption keys, the existing VPN session must be closed, and the network session must be renegotiated in order to effect the key exchange. For a variety of reasons, such key exchange may be carried out infrequently, which raises the risk of the encryption keys being “broken,” in turn allowing a hacker or intruder to access and view the data being transmitted across the VPN. The renegotiation of the network session (i.e., closing and reopening the encrypted session) in order to effect the key exchange carries a significant performance cost. Moreover, the mere act of renegotiating the network session in order to effect the key exchange may indicate to any outside observers monitoring the VPN that the encryption keys are being replaced, giving those observers additional information that they can use to attempt to break the encryption keys.

It would therefore be advantageous to provide a system and method capable of carrying out key exchange within a VPN that avoids the disadvantages noted above, and particularly that can be carried out frequently with minimal performance cost and without alerting outside observers to the fact that encryption keys are being exchanged.

### SUMMARY OF THE INVENTION

Disclosed is a system and method for maintaining a secure, encrypted networking session across a communications network by dynamically replacing encryption keys during the networking session and without terminating the session. A secure control channel is embedded within the general encrypted network connection and is used to transport encrypted control messages from one network endpoint to another. In order to hide that fact that such control messages are being transferred (as opposed to general network data traffic), the control message data packets are formatted in a data structure that simulates the standard general network data packets.

With regard to one aspect of a particularly preferred embodiment of the invention, a computer implemented method is disclosed for exchanging data encryption keys during an encrypted networking session without terminating the encrypted networking session, comprising the steps of establishing an encrypted network session between network data end points, distributing encrypted general network session data packets through the encrypted network session, and distributing replacement encryption keys among the network data end points during the encrypted network session and without terminating the encrypted network session. The replacement encryption keys comprise general network session encryption keys and control data encryption keys that are distinct from the general network session encryption keys. The control data encryption keys are transmitted through the encrypted network session in encrypted control data packets having a data packet structure configured to simulate a data packet structure of the encrypted general network session data packets.

With regard to another aspect of a particularly preferred embodiment of the invention, a system is disclosed for exchanging data encryption keys during an encrypted networking session without terminating the encrypted networking session, comprising a first encryption service appliance in data communication with one or more first local network operational nodes, and a second encryption service appliance in data communication with one or more second local network operational nodes, wherein the second encryption service appliance is in data communication with the first encryption service appliance across a communications network. Each of the first encryption service appliance and the second encryption service appliance have executable computer code stored thereon that is adapted to: (i) establish an encrypted network session between the first encryption service appliance and the second encryption service appliance; (ii) distribute encrypted general network session data packets from the one or more first local network operational nodes to the one or more second network operational nodes through the encrypted network session; and (iii) distribute replacement encryption keys among the first encryption service appliance and the second encryption service appliance during the encrypted network session and without terminating the encrypted network session. The replacement encryption keys comprise general network session encryption keys and control data encryption keys that are distinct from the general network session encryption keys. The control data encryption keys are transmitted through the encrypted network session in encrypted control data packets having a data packet structure configured to simulate a data packet structure of the encrypted general network session data packets.

### BRIEF DESCRIPTION OF THE DRAWINGS

The numerous advantages of the present invention may be better understood by those skilled in the art by reference to the accompanying drawings in which:

FIG. 1 is a diagrammatic representation of an exemplary computer network employing the encryption rekeying system and method of the invention.

FIG. 2 is a block diagram of an encryption service appliance according to certain aspects of the invention.

FIG. 3 is a flow diagram showing certain aspects of a process of the invention.

FIG. 4 is a flow diagram showing further aspects of a process of the invention.

FIG. 5 is a schematic view of a representative hardware system which may be employed as part of the system and for execution of the methods of the invention.

### DETAILED DESCRIPTION OF THE INVENTION

The following description is of a particular embodiment of the invention, set out to enable one to practice an implementation of the invention, and is not intended to limit the preferred embodiment, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

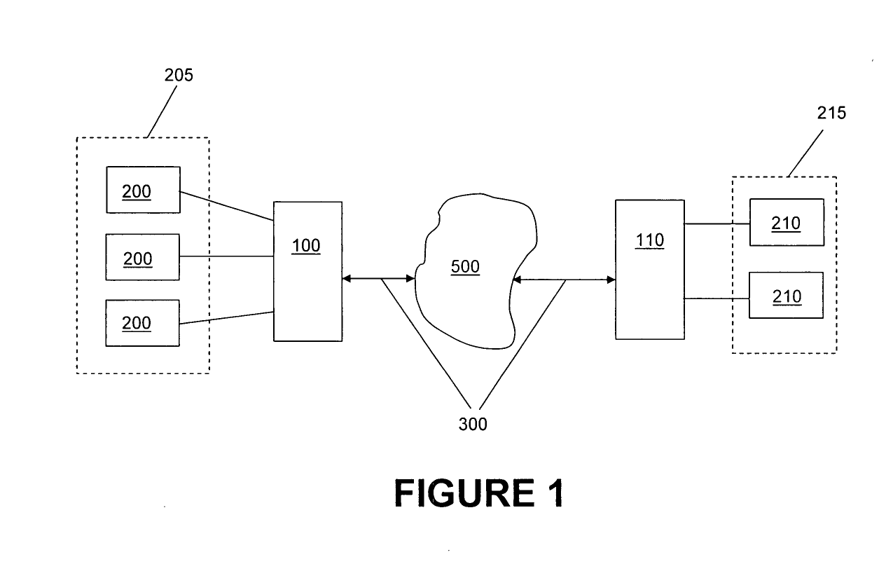

FIG. 1 shows an exemplary distributed network system employing certain aspects of a particularly preferred embodiment of the invention. As shown in FIG. 1, a primary encryption service appliance 100 is provided, which appliance 100 may be implemented in the form of a dedicated hardware device using any typical computing system (e.g., a personal computer, a server, etc.) having appropriate network interfaces as are known to those of ordinary skill in the art. Such computing system may also have specialized hardware for performing tasks such as encryption, performance accelerators, activity monitors, and the like. Alternatively, primary encryption service appliance 100 may be implemented by way of software executed on a general purpose computing platform. A similarly configured secondary encryption service appliance 110 is likewise provided, and is in data communication with primary encryption service appliance 100 via a network 500. Network 500 may comprise, by way of non-limiting example, a local area network (LAN), a wide area network (WAN) such as the Internet, or any other network structure that might be used to communicate various network nodes (comprising various computing devices and services) to one another.

One or more network operational nodes 200 are in data communication with primary encryption service appliance 100, and may (by way of non-limiting example) comprise various computing platforms (e.g., enterprise server computers, client computers, personal computers, laptop computers, etc.), other hardware devices (e.g., printers, copiers, scanners, etc.), computing services (e.g., internet access, VoIP services, etc.), and the like. Network operational nodes 200 may themselves be interconnected with one another to form their own LAN 205. Similarly, one or more network operational nodes 210 are in data communication with secondary encryption service appliance 110, which in turn may comprise various computing platforms, other hardware devices, computing services, and the like that communicate with network operational nodes 200 across network 500. Network operational nodes 210 may be interconnected with one another to form their own LAN 215, and LAN 205 and LAN 215 may communicate with one another across network 500 by routing network traffic through primary encryption service appliance 100 and secondary encryption service appliance 110, as described in further detail below. Optionally, multiple secondary encryption service appliances 110 may be provided (each in communication with their own associated LAN) and communicate with primary encryption service appliance 100. By way of non-limiting example, local networks 205 and 215 may optionally comprise enterprise data centers communicating with one another through network 500 across encrypted connection 300.

Primary encryption service appliance 100 and secondary encryption service appliance 110 are configured to establish an encrypted point-to-point connection 300, and data traffic transmitted between network operational nodes 200 and network operational nodes 210 is passed through such encrypted connection 300 across network 500. As is detailed further below, such an encrypted session preferably uses either AES 128 or AES 256 encryption keys, and those encryption keys are dynamically replaced frequently during the encrypted network session, and particularly without closing the encrypted network session, so as to make it extremely difficult to break the encryption of the link between primary encryption service appliance 100 and secondary encryption service appliance 110. Control information that is used to manage the encryption key exchange process is carried by a secure “control channel” within the encrypted session itself, thus making it highly difficult for a third party monitoring the network session to determine even that a key exchange is occurring.

Primary encryption service appliance 100 produces new encryption keys that are delivered to secondary encryption service appliance 110 to be used for encrypting network sessions. Such encryption keys are changed at particular intervals or upon the occurrence of particular network events that may be selected by a network system administrator so as to provide a secure channel without disrupting the network session. In order to ensure the protection of the replacement encryption keys, an encrypted control channel within the session encrypted connection 300 is established to handle the dynamic replacement of those keys so as to make it extremely difficult to break the encryption of the link. The encryption keys are preferably maintained only as long as they are in use.

The encryption service appliances 100 and 110 are suitable for use in an environment in which all hosts on the data network are controlled by the organization's central management. In such an architecture, it is desirable for the encryption service appliances 100 and 110 to provide support for operating system user authorization, and support for both IPv4 and IPv6 networks. Moreover, all such appliances should have a static routing table defined to be able to forward packets to or from the local network correctly.

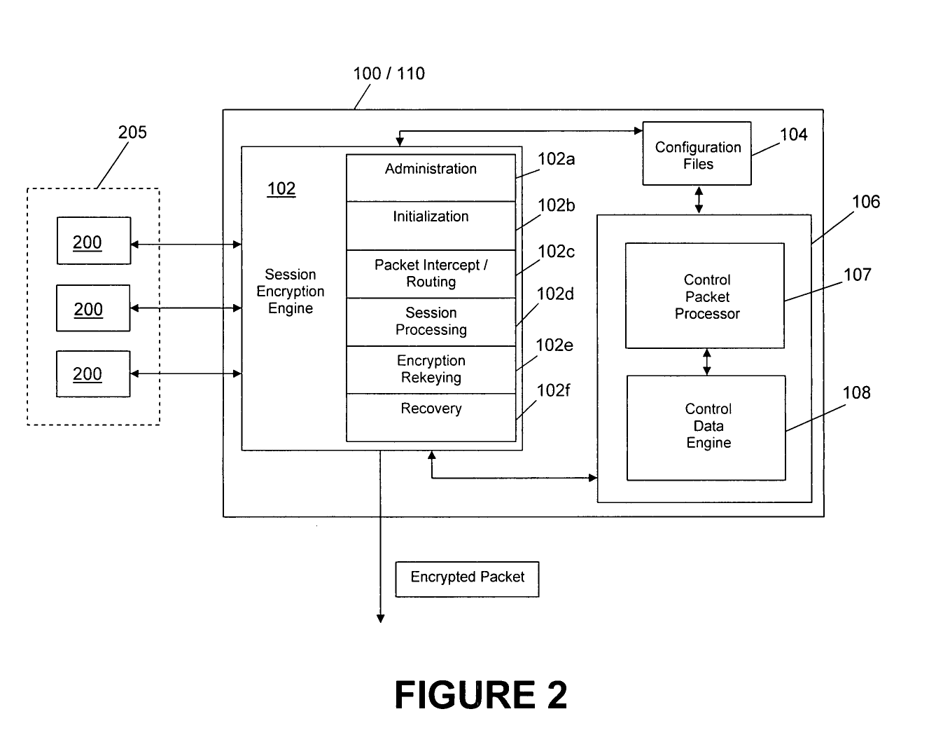

As shown in FIG. 2, each encryption service appliance 100 and 110 preferably includes a session encryption engine 102 that is responsible for managing various functions in addition to general encryption of data packets from network operational nodes 200 that are to be transmitted across network 500, including system administration, network session initialization, data packet intercept and routing, session processing, encryption rekeying, and session recovery, each of which is further detailed below. The actions taken during these processes are logged, and if there are any failures, error messages are issued to the enterprise logging facility.

First, session encryption engine 102 includes an administration function 102a that provides the interface to manage and modify configuration files 104. The data in configuration files 104 are used during initialization of the encryption service appliances, and preferably include at least the following: (i) identification of the encryption algorithm, which may for instance be either AES 128 or AES 256; (ii) a list of secondary encryption service appliances that are allowed to establish connections with a particular primary encryption service appliance; (iii) if the particular encryption service appliance is to be a designated secondary encryption service appliance, the IP address of the primary encryption service appliance with which it may establish connections; (iv) the number of keys to be included in a key array, which key array comprises a listing of replacement encryption keys; and (v) a routing table for directing network traffic. The routing table preferably includes at least a destination network field (one of the networks that is local to the secondary encryption service appliance being defined), a network mask (the network mask of that local network), and the system address (the IP address of the secondary encryption service appliance).

The majority of encryption service appliance administration is performed from a to primary encryption service appliance 100. However, the initial deployment of a secondary encryption service appliance 110 will require the local IP addresses and the IP address of the primary encryption service appliance 100 to which the secondary encryption service appliance 110 may establish a connection. If the IP addresses are not already set when the secondary encryption service appliance 110 is powered up, the administrator may be prompted for this information.

An administration function 102a provides a network administrator various tools, including user creation, user validation, encryption key algorithm designation, rekeying period frequency, routing table definition, and designation of an encryption service appliance as a secondary encryption service appliance. With regard to user creation, administration function 102a provides preferably three levels of access for authorized administrators, wherein each level includes the privileges of the levels below them. The restrictions on access may include a first or lower level (“Level 1”), which allows for access to logging information only, a second level (“Level 2”), which allows access to existing sessions for shutdown or restart, and a third level (“Level 3”), which allows full access to modify configuration parameters and create new administrators. Next, with regard to user validation, administration function 102a may validate each user's authorized access before performing any function, such as by requiring entry of recognized username and password data. In the user interface, unauthorized functions are preferably not displayed to the user. Next, with regard to encryption key algorithm designation, the primary encryption service appliance 100 generates keys using the NIST FIPS 197 Advanced Encryption Algorithm, with a key size of either 128 or 256 bits, and is configured by an authorized administrator. Next, with regard to the rekeying period, the keys used to encrypt a session between the primary encryption service appliance 100 and a secondary encryption service appliance 110 are replaced periodically, and the frequency of replacement is configured by an authorized administrator. While various circumstances or events may be used to determine that a key replacement operation is to take place, any such circumstance or event should be selected so as to avoid using a known interval, and may include (by way of non-limiting example) designated time intervals and/or numbers of data packets sent. Next, with regard to routing table definition, the primary encryption service appliance 100 may have sessions with multiple secondary encryption service appliances 110, in which case the primary encryption service appliance routing table must be defined to identify all network destinations for each secondary encryption service appliance 110. Last, with regard to secondary designation, a primary encryption service appliance 100 may operate as a secondary encryption service appliance 110 with another primary/secondary system. If given the secondary designation, a primary encryption service appliance 100 will appear to be a secondary encryption service appliance 110 to that other system.

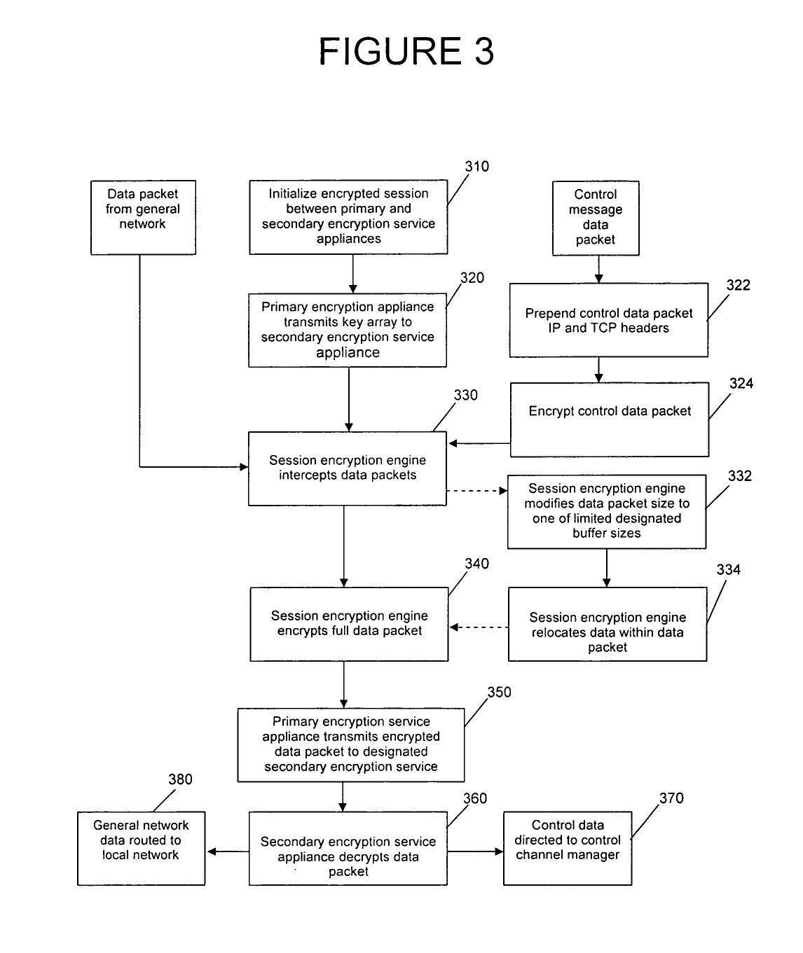

Next, with reference to both FIG. 2 and the flow diagram of FIG. 3 showing certain aspects of a process of the invention, an initialization function 102b manages establishment of the connection between primary encryption service appliance 100 and secondary encryption service appliance 110. The initialization function 102b conforms to the IPsec standard defined in RFC 4301 and its supporting standards, which are incorporated herein by reference. That protocol is modified as described herein to enable the encryption keys to be replaced dynamically. During initialization at step 310, a secondary encryption service appliance 110 makes a connection request to the primary encryption service appliance 100 in order to initiate a main network session (i.e., a networking session in which one or more network operational nodes 200 communicate with one or more network operational nodes 210 across network 500). In one embodiment of the invention, secondary encryption service appliances 110 are not configured to accept connection requests themselves. There are three steps to establish the main encrypted session, as follows. First, the secondary encryption service appliance 110 makes a connection request to the primary encryption service appliance 100 based on a configuration file 104 with a list of valid primary encryption service appliance network addresses defining the order of connection attempts. The primary encryption service appliance uses a configuration file 104 with a list of valid secondary encryption service appliance 110 network addresses to determine whether the request is valid, and if so accepts the connection request. With regard to one aspect of a particularly preferred embodiment of the invention, this determination includes a requirement for extra validation in the event of a session failure, as described in greater detail below. Further verification methods may also be utilized, such as by using the “Status Request” control message detailed below. The main session is then initialized using the Internet Key Exchange version 2, as defined in RFC 4306. This includes support for Internet Security Association and Key Management Protocol (ISAKMP), as defined in RFC 2408, Internet Key Exchange (IKE), as defined in RFC 2409, and the Authentication Header (AH), as defined in RFC 4302.

When a main network session is established, the primary encryption service appliance 100 also initializes a control channel, which in turn comprises an encrypted session established between the primary encryption service appliance 100 and the secondary encryption service appliance 110 that is used to exchange control information between them. Those of ordinary skill in the art will recognize that such control channel need not comprise a separate physical communication channel from the connection that carries the general network session, but does particularly refer to a secure communication signal between encryption service appliances and forming a part of the main session communication. The control channel data packets are treated the same as any other data from the perspective of the main network session. As described in further detail below, the control channel encrypted session is encrypted with keys that are different from those used for the main network session. The control session communicates information between the encryption service appliances 100 and 110 by exchanging control messages as described in further detail below. In order to initialize the control channel using control messages, the primary encryption service appliance 100 at step 320 preferably sends the secondary encryption service appliance 110 a “Set Key Array” message (detailed below). If the secondary encryption service appliance 110 sends a successful response, initialization continues. Otherwise, preferably two more attempts are made, and if neither is successful, the main encrypted session is closed and session recovery is initiated, as detailed below. Following a successful response, the primary encryption service appliance 100 performs the encryption rekeying function 102e described below. The primary encryption service appliance 100 also sends a “Status Request” message for additional information to validate the identity and readiness of the secondary encryption service appliance 110. If this step is not completed successfully, the main encrypted session is closed and session recovery is initiated.

Next, at step 330 a packet intercept and routing function 102c intercepts and routes data packets to their intended destination. Each encryption service appliance must intercept packets with the IP and other protocol headers intact. The packets are then encrypted at step 340, and at step 350 are forwarded to the correct encryption service appliance, which in turn decrypts the packet at step 360 and forwards it the intended destination. If a primary encryption service appliance 100 establishes sessions with more than one secondary encryption service appliance 110, it routes packets to the correct secondary encryption service appliance 110 through the main network session. In order to accomplish this, the primary encryption service appliance 100 uses a routing table to match the destination IP address of each packet to the correct secondary encryption service appliance 110.

In the outbound packet intercept process, the “sending” encryption service appliance, and particularly session encryption engine 102 of such encryption service appliance, intercepts each packet destined for another “receiving” encryption service appliance with the IP and other protocol headers intact. If there are multiple connections established, the destination address is matched using a system routing table definition. The destination IP address is ANDed with the subnet mask of each entry in the table, and if the result equals the network address of that entry, the packet is forwarded to the system IP address of that entry. Then, the full packet is encrypted and forwarded to the correct “receiving” encryption service appliance. In the inbound packet intercept process, the encrypted packet data is decrypted by the session encryption engine 102. If the destination IP address of the packet is the receiving encryption service appliance itself, the packet data at step 370 is forwarded to a control channel manager 106 and is handled specially as further detailed below; otherwise, the full packet is forwarded to the local network at step 380. The encryption service appliance's special handling of control channel data is managed by control channel manager 106, and includes encryption and decryption by control packet processor 107 using the control channel encryption key (generated and maintained by control data engine 108) and bypassing the TCP/IP stack to manage the unencrypted data, all as further detailed below.

In the outbound control packet process, predefined headers, which are further detailed below, are prepended to the control data at step 322 by control packet processor 107. Then, the full control data packet is encrypted at step 324 and forwarded to session encryption engine 102, where the result is treated by session encryption engine 102 like normal network session data (i.e., data received from network operational nodes on the local network). In the inbound control packet process, the full packet is first decrypted at step 360 by session encryption engine 102. The control data is then at step 370 forwarded directly to the control packet processor 107 to be processed, again as further detailed below.

Next, a session processing function 102d manages packaging of data packets that are to be transmitted across network 500, whether those data packets are control channel data packets from control channel manager 106 or main session data packets from network operational nodes 200 in a local network communicating with the encryption service appliance. More particularly, session processing function 102d may handle main session data encryption, data transport, main session data decryption, control channel data encryption, and control channel data decryption. With regard to main session data encryption, the full IP packets received from the local network 205 are encrypted and used as the payload data of the encrypted packet that is transmitted across network 500. In order to format packets for transport across network 500, the packets are structured using a special format. More particularly, session encryption engine 102 sets the IP protocol field to 50, which is defined by the Internet Assigned Numbers Authority (IANA) as Encapsulating Security Protocol (ESP), and inserts a 16-bit field after the IP header. In one embodiment of the invention, the encryption service appliance supports only one usage scenario defined in the IKEv2 specification: Security Gateway to Security Gateway Tunnel. The format of IP version 4 encrypted packets is:

| 20 octets | 4 octets | 4 octets | Variable length |
| IP Header | Flags | Packet ID | Encrypted Data |

Likewise, the format of IP version 6 encrypted packets is:

| 40 octets | 4 octets | 4 octets | Variable length |
| IP Header | Flags | Packet ID | Encrypted Data |

where the fields are as follows:
IP Header: the standard version 4 or version 6 IP header with the protocol field set to 50 (ESP).
Flags: currently reserved.
Packet ID: the identification number of the packet is an unsigned 32-bit integer. It indicates which encryption key is used to decrypt the packet payload. The ID is incremented for each packet by the encryption service appliance transmitting it. When the maximum value is reached, the next value is zero. When rekeying occurs (as discussed in detail below), the ID of the first packet to be encrypted and decrypted using the new key is set. The starting ID of the previous key and the starting ID of the new key set the bounds (modulo 2³²) for the packets to be decrypted using the previous key. This allows for out of order packets to be decrypted using the correct key. Further, the ID is unique to each half session. In other words, when rekeying occurs, the starting ID for packets from the primary encryption service appliance 100 to the secondary encryption service appliance 110 will usually be different from that of packets from the secondary to the primary.
Encrypted data: the particular data that is encrypted prior to transmission across network 500.

With regard to main session data decryption, data received by one encryption service appliance from the other is decrypted, which may (in accordance with one embodiment of the invention) be handled in hardware. After such main session data decryption is completed, a determination is made of where such data is to be directed. Specifically, if the destination is the receiving encryption service appliance itself, the data is forwarded to control channel manager 106 for processing. Otherwise, the data is forwarded to its intended destination in the local network associated with the receiving encryption service appliance.

If control channel data is to be sent from one encryption service appliance to another, a predefined UDP header is prepended to the encrypted control data packet (which has been encrypted control packet processor 107 using the control encryption key) before the full packet is encrypted by session encryption engine 102. Both the source and destination ports in this header are preferably set to the port on which the secondary encryption service appliance requests a connection with the primary encryption service appliance. The checksum calculation is not required. A predefined IP header is then prepended. The source and destination address fields are fixed for the duration of the network session. However, all other fields are handled according to the IP protocol specification for version 4 or version 6. The entire packet is then transferred to and handled by session encryption engine 102 the same as any network session data packet.

Moreover, if, after session encryption engine 102 decrypts an incoming packet, the destination is seen to be the receiving encryption service appliance itself, the packet is directed to control channel manager 106 (and more particularly to control packet processor 107). If the source and destination ports of the UDP header are not both set to the port on which secondary encryption service appliance 110 requests a connection with the primary encryption service appliance 100, the packet is ignored. Otherwise, the packet is decrypted using the control encryption key. The IP and UDP headers are then removed from the decrypted control data packet, and the data is handled by the control data engine 108 as described in further detail below.

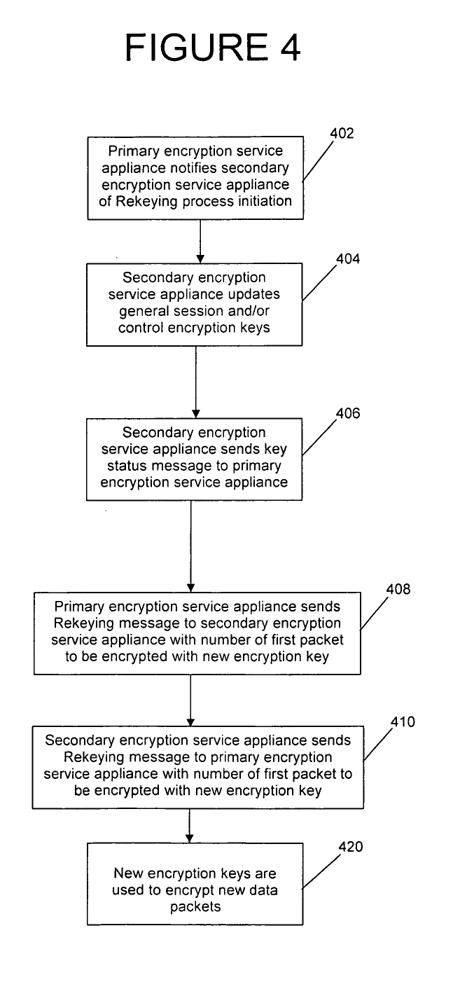

Next, and with reference to the flow diagram of FIG. 4 showing certain aspects of a process of the invention, an encryption rekeying function 102e of session encryption engine 102 manages replacement of encryption keys frequently throughout the network session without terminating the session. When such rekeying process is to occur, at step 402 the primary encryption service appliance 100 notifies the secondary encryption service appliance 110, supplies the new keys, and indicates the rekeying point. The primary encryption service appliance 100 generates new keys for both the main session and the control channel. The primary encryption service appliance 100 may generate a new key or randomly select a new key from the key array. During session initialization, the primary encryption service appliance preferably sends such key array (i.e., an array of encryption keys) to the secondary encryption service appliance 110 and maintains the array in its information for that secondary encryption service appliance, preferably within configuration files 104. The encryption keys are replaced using specially configured control messages, which are further detailed below. In general, the primary encryption service appliance 100 sends a “Key Replacement” control message with the data and control key values to the secondary encryption service appliance 110, and a flag set to indicate whether each key is an actual key or an index into the key array. When the secondary encryption service appliance 110 receives the control message, it determines whether either key is in the key array, and if so, retrieves the key. It then prepares the encryption module to use the new key as follows.

Configuration files 104, which are accessible by session encryption engine 102, maintain four keys and two packet indexes as follows:
Data Key 0: this is the “old” encryption key for the main network session encryption.
Control Key 0: this is the “old” encryption key for the control message encryption.
Packet Index 0: this is the number of the first packet encrypted using data key 0.
Data Key 1: this is the “new” encryption key for the main network session encryption.
Control Key 1: this is the “new” encryption key for the control message encryption.
Packet Index 1: this is the number of the first packet encrypted using data key 1.
   When the new keys from a “Key Replacement” message have been determined, the secondary encryption service appliance 110 at step 404 copies Data Key 1 to Data Key 0 and Control Key 1 to Control Key 0. It also sets the Packet Index for both Keys 0 to that of Keys 1. The Packet Index of Keys 1 is incremented and then the new Data Key 1 and Control Key 1 are set. If there is an error at any point, a Key Status message is sent with the appropriate error flag bit set (as detailed below) and the keys and packet indexes are restored. Otherwise, at step 406 a Key Status message is sent with all error flag bits set to zero.

When received, the primary encryption service appliance 100 handles the Key Status message as follows. If the Key Status message is not received within a timeout period, it sends a duplicate of the Key Replacement message with the Retransmit flag bit set. If more than preferably four retransmitted messages are sent, the session is closed. An implementation may devise a method of session recovery which would be executed at this time. Likewise, if the Key Status message is received with errors, it again sends a duplicate of the Key Replacement message with the Retransmit flag bit set. If more than preferably four retransmitted messages are sent, the session is closed. An implementation again may devise a method of session recovery which would be executed at this time. However, if the Key Status message is received with no errors, the primary encryption service appliance 100 at step 408 sends a Rekeying message to the secondary encryption service appliance 110, with the number of the first packet to be encrypted with the new encryption key. All data then sent over the main encrypted session or through the control channel is encrypted with the new data or control key at step 420. Any packet received by the secondary encryption service appliance 110 from the primary service appliance 100 with a number between Packet Index 0 and Packet Index 1 (modulo 2³²) is decrypted using data or control key 0.

Similarly, when the secondary encryption service appliance 110 receives the Rekeying message, it sends a Rekeying message at step 410 to the primary encryption service appliance 100, with the number of the first packet to be encrypted with the new key. All data sent over the main encrypted session or through the control channel is then encrypted with the new data or control key at step 420. Any packet received by the primary encryption service appliance 100 from the secondary encryption service appliance 110 with a number between packet index 0 and packet index 1 (modulo 2³²) is decrypted using data or control key 0.

Next, session recovery process 102f of session encryption engine 102 manages recovery if a session is lost. However, in order to minimize the likelihood of loss of a session, a cluster group of primary encryption service appliances 100 and secondary encryption service appliances 110 may optionally be provided. In a clustering mode of operation, there may be multiple encryption service appliances that all share the same IP address. In a failover mode of operation, a backup may take over the functions of the main encryption service appliance. In any event, if the session is lost despite such clustering and/or failover configurations, session recovery process 102f may safely terminate the session and notify administration personnel.

Session recovery process 102f is configured to determine that a session with a secondary encryption service appliance has failed if a network error is reported by the TCP/IP stack, and/or if there is no answer to any “Heartbeat Query” control messages within a predetermined amount of time, and preferably a 4-minute period. When a session failure is determined, session recovery process 102f terminates the login, whereby all enterprise connections to the primary encryption service appliance 100 are immediately terminated. In the case of TCP sessions, this should be done by sending a Reset. For other protocols, an ICMP Destination Unreachable packet may be generated. An error message with all available information on the failure is preferably logged to the enterprise logging facility to notify administrators of the failure.

In addition, in the event of the loss of a session, the session recovery function 102f of the secondary encryption service appliance 110 is also configured to determine that a session with a primary encryption service appliance 100 has failed if a network error is reported by the TCP/IP stack, and/or if no “Heartbeat Query” messages are received within, for example, a 4-minute period, even after an unsolicited “Heartbeat Answer” message has been sent. Upon a determination that such a failure has occurred, secondary encryption service appliance 110 may also terminate the login, whereby all enterprise connections to the secondary encryption service appliance 110 are immediately terminated. Once again, in the case of TCP sessions, this should be done by sending a Reset, and for other protocols, an ICMP Destination Unreachable packet may be generated. After a brief wait, the secondary encryption service appliance 110 may attempt to automatically reestablish the session with the primary encryption service appliance 100, and continue to do this periodically. The first time, the secondary encryption service appliance may set the wait period, for example, for 5 seconds, and after that period, attempt to connect to the primary encryption service appliance. Each time the connection cannot be established, an additional time period, for example 5 seconds, may preferably be added to the wait time and after that period, the connection may be attempted. When the wait period is preferably 1 minute, the wait time is preferably not further increased, so that the secondary appliance 110 may attempt to connect to the primary appliance 100 once a minute.

Those of ordinary skill in the art will recognize that the above-described functions need not be separate and distinct software or hardware modules, and in fact that functions may be shared among one or more notional functional modules, without departing from the spirit and scope of the invention.

As explained above, session encryption engine 102 is responsible for encrypting data packets that are transmitted across network 500 through encrypted connection 300. In addition to the encryption formatting described above, data packets transmitted across network 500 may be further secured in the following ways.

First, packet sizes for all data packets transmitted across network 500 may be limited to a particular set of packet sizes. During network session setup or shutdown, many protocols exchange standardized messages. Because these are typically small enough to fit into less than a full Ethernet packet, it could be possible to identify them by monitoring the network traffic for patterns in the size of packets. In order to prevent these patterns, the encryption service appliance may limit buffer sizes to less than five, and more preferably three buffer sizes, including small (e.g., 176 or fewer bytes, and more preferably 176 bytes), medium (e.g., between 176 and 640 bytes, and more preferably 640 bytes), and large (e.g., more than 640 bytes, and more preferably full Ethernet packets).

Second, and with reference to step 332 of FIG. 3, pad characters may optionally be added to the data packet from existing data already in the packet in order to fit each packet to one of the limited designated buffer sizes. For packets that are smaller than the buffer size being used, pad characters must be added. If these were all zeros, it would be possible to target the end of packets when attempting to break the encryption key. Therefore, non-zero pad characters may be added. In order to make the characteristics of the data consistent, the pad characters can be taken from the data. The pad characters may thus be generated by selecting a random number, such as a checksum, and selecting the 3 lower order bits, to be used as a step value. If this value is zero, then another step value is selected. If the size of the data is at least three times the step counter, preferably only the data is used. Otherwise, the headers may be counted as data. An index is set to the step counter value and the first pad character is the data at the index offset. The index is incremented by the step counter and the second pad character is at the offset of the new index. If the value of the index exceeds the length of the data, the length of the data is preferably subtracted from the index and the next pad character is located at the offset of the new index.

Third, and with reference to step 334 of FIG. 3, data may optionally be relocated within a packet. More particularly, unencrypted network protocol header data at the beginning of the encrypted packet contains addresses that are usually within the destination network of the encrypted header. These and other header fields could be used as somewhat constant data for breaking the encryption key. In order to make the beginning of the data vary between packets, each buffer to be encrypted is divided into two to eight blocks of varying size. Each of these blocks is randomly shuffled with a mapping of how to reassemble them included in the data. The data may then be encrypted. In order to accomplish such relocation, the mapping of shuffled blocks is preferably organized as follows:

| 1 byte | 2 bytes | Variable |
| Index | Length | Block |

There are two to eight “Index/Length/Block” fields. The format of the fields are:
Index: index of the block for reassembling purposes. The indexes start at zero and end between 1 and 7.
Length: the length of the block following this field.
Block: the actual data in the block, which is reassembled in order by the receiving encryption service appliance.

As mentioned above, during the rekeying process, the encryption keys are replaced using specially configured control messages. Likewise, generally system status determinations are made using control messages. In summary, control messages are the method by which encryption service appliances manage the encryption session and keys. The general format of a control message is:

| 4 octets | 1 octet | Variable length |
| Size | Command | Data |

where the fields are:
Size: the total size of the message, including the size field itself
Command: an 8-bit number.
Data: the data, if any, associated with the particular command.
   Each of the currently envisaged control messages are defined below, with the associated command number in parentheses. Those of ordinary skill in the art will readily recognize that the particular format of such commands, and the particular reference command numbers associated with them, are exemplary only and can be modified without departing from the spirit and scope of the invention. Moreover, additional commands beyond those detailed here may likewise be provided as appropriate to accommodate particular applications and network environments in which encryption service appliances might be used.

Set Key Array (1): a primary encryption service appliance 100 may generate a list of keys that is maintained in memory by the secondary encryption service appliance 110. During Rekeying as described above, the index into the list can be used to assign a new key. This message may be sent at any time during the session. The Set Key Array data fields are:

| 1 octet | 3 octets | Variable length |
| Flags | Key array size | Key array |

where the fields are:
Flags: the flag field is a bit field with the following values:

$$1111 … = Reserved ( ignored )$$

$$… 1111 = Encryption type$$

where the supported encryption types are 1=AES 128, key length 128 bits, and 2=AES 256, key length 256 bits.
Key array size: the number of keys in the array.
Key array: the list of keys to be stored in the key array.

Key Array Acknowledgement (2): the Key Array Acknowledgement data fields are:

| 1 octet |
| Flags |

where the fields are:
Flags: the flag field is a bit field in which success is indicated by zero errors. Otherwise, the following errors are defined:

$$111111 … = Reserved ( ignored )$$

$$… 1. = Error saving key array$$

$$… … 1 = Error in control data$$

Key Replacement (3): the value of a new key is sent before the notification of its use. The Key Replacement data fields are:

| 1 octet | Index or key length | Index or key length |
| Flags | Data Key | Control Key |

where the fields are:

Flags: the flag field is a bit field with the following values:

$$11111 … = Reserved ( ignored )$$

$$… 1 … = Retransmit$$

$$… 1. = Data encryption key from array ( DINDEX )$$

$$… … 1 = Control encryption key from array ( CINDEX )$$

Data Key: if the DINDEX flag bit is set, the length is 4 octets, and the value is the index into the key array, which was set using the Set Key Array message. Otherwise, the field is the new data encryption key, and the length depends on the encryption type.

Control Key: if the CINDEX flag bit is set, the length is 4 octets, and the value is the index into the key array, which was et using the Set Key Array message. Otherwise, the field is the new control encryption key, and the length depends on the encryption type.

Key Status (4): the Key Status fields are:

| 1 octet |
| Flags |

where the field is:
Flags: the flag field is a bit field with the following values:

$$1111 … = Reserved ( ignored )$$

$$… 1 … = Error in data key index$$

$$… 1 … = Error in data key$$

$$… … 1. = Error in control key index$$

$$… … 1 = Error in control key$$

Rekey (5): the Rekey data fields are:

| 4 octets |
| Packet Index |

where the field is:
Packet Index: the number of the first encrypted packet to use the new keys. This field follows the Encapsulating Security Header.

Heartbeat Query (6): the Heartbeat Query data fields are:

| 4 octets | 4 octets |
| Timestamp | Sequence # |

where the fields are:
Timestamp: the timestamp is the time that the primary encryption service appliance 100 sends the message. This field is composed of two values: the high order 20 bits are the number of seconds after midnight; the low order 12 bits are the high order 12 bits of the system sub-second time.
Sequence #—the sequence number starts at one and is incremented each time a heartbeat query is sent. When the maximum value is reached, the next value is one.

Heartbeat Answer (7): the Heartbeat Answer data fields are:

| 4 octets | 4 octets |
| Timestamp | Sequence # |

where the fields are:
Timestamp: the timestamp is the time that the secondary encryption service appliance 110 sends the message. This field is composed of two values: the high order 20 bits are the number of seconds after midnight. The low order 12 bits are the high order 12 bits of the system sub-second time.
Sequence #: the sequence number is that of the Heartbeat Query message being answered. If the number is zero, the status is unsolicited, which requires an immediate Heartbeat Query from the primary encryption service appliance 100.

The heartbeat information is sent preferably 5 to 30 seconds to validate that the session is established. The timestamp data is used to calculate the average round trip time of control information. The period is configurable, but if no query or answer is received for a period of preferably 4 minutes, the session is assumed to have failed.

Status Request (8): the Status Request data fields are:

| 2 octets | 2 octets | Variable length |
| Request # | Request size | Status request |

where the fields are:
Request #: the request number starts at one and is incremented each time a Status Request is sent. When the maximum value is reached, the next value is one.
Request size: the number of Status Request fields.
Status requests: each status request is a text field terminated by the NULL character.

Status Response (9): the Status Response data fields are:

| 2 octets | 2 octets | Variable length |
| Request # | Response size | Status Responses |

where the fields are:
Request #: the request number is that of the Status Request message being answered. If the number is zero, the status is unsolicited, which means it is an alert message.
Response size: the number of Status Response fields.
Status Responses: each status response is a text field of the form “Key=Value”, and terminated by the NULL character.

Update Information (10): the Update Information data fields are:

| 1 octet | 4 octets | Variable length |
| Flags | Update size | Update data |

where the fields are:
Flags: the flag field is a bit field with the following values:

$$111111 … = Reserved ( ignored )$$

$$… … 1. = Update is configuration$$

$$… … 1 = Update is code$$

Update size: the length in octets of the Update Data.
Update Data: the update data.

Update Acknowledgement (11): the Update Acknowledgement data fields are:

| 1 octet |
| Flags |

where the field is:
Flags: the flag field is a bit field in which success is indicated by zero errors. Otherwise, the following errors are defined:

$$111111 … = Reserved ( ignored )$$

$$… … 1. = Error applying update$$

$$… … 1 = Error in update data$$

Shutdown (12): the Shutdown data fields are:

| 1 octet |
| Flags |

where the field is:
Flags: the flag field is a bit field in which success is indicated by zero errors. Otherwise, the following errors are defined:

$$111111 … = Reserved ( ignored )$$

$$… … 1. = Restart after maximum timeout$$

$$… … 1 = Restart immediately$$

Shutdown Acknowledgement (13): the Shutdown Acknowledgement data fields are:

| 1 octet |
| Flags |

where the field is:
Flags: the flag field is a bit field in which success is indicated by zero errors. Otherwise, the following errors are defined:

$$111111 … = Reserved ( ignored )$$

$$… … 1 = Shutdown acknowledged$$

The encryption service appliances may use status requests to exchange information and status between them. Those status requests may include DISK, in which the amount of disk space available to the system is reported. A primary encryption service appliance 100 may send this Status Request message, or a secondary encryption service appliance 110 may send this Status Response unsolicited as an alert. The response to a DISK request is of the form DISK=#, where # is the number of kilobytes of available disk space. Another such available status request is CPUMAX, in which the maximum amount of CPU usage since the previous CPUMAX Status Request message is reported. A primary encryption service appliance may send this Status Request message, or a secondary encryption service appliance may send this Status Response unsolicited as an alert. The response to the CPUMAX request is of the form CPUMAX=#, where # is the maximum CPU usage as a percentage. Further, yet another available status request is CPUAVG, in which the average amount of CPU usage since the previous CPUAVG Status Request message is reported. A primary encryption service appliance may send this Status Request message, or a secondary encryption service appliance may send this Status Response unsolicited as an alert. The response to the CPUAVG request is of the form CPUAVG=#, where # is the average CPU usage as a percentage.

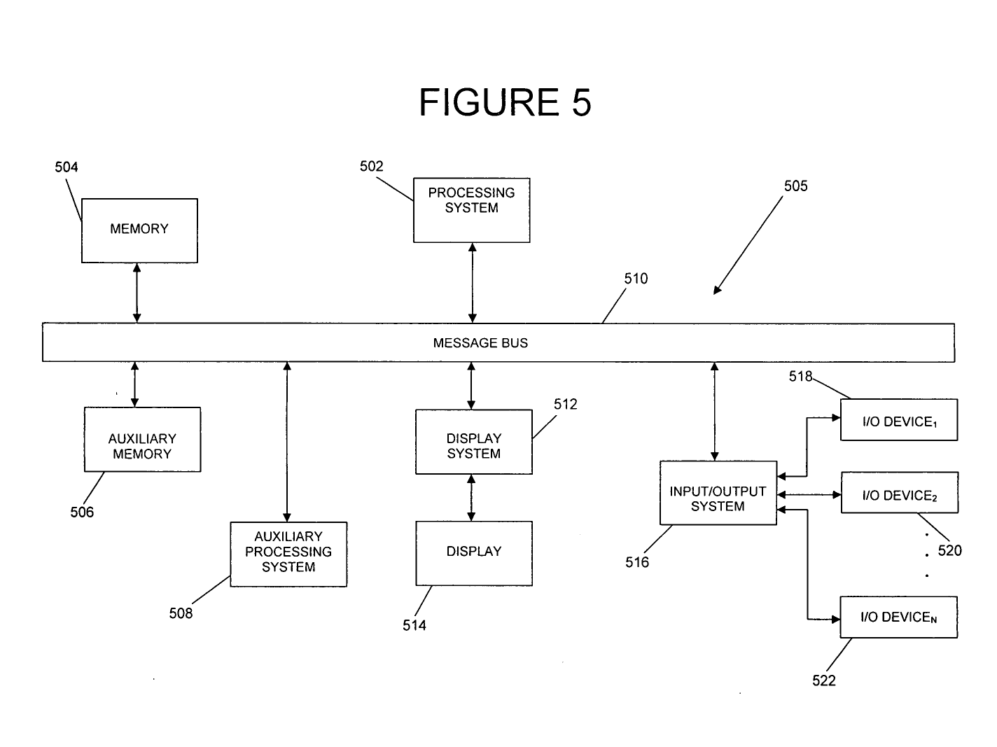

Once again, encryption service appliances 100 and 110 may, in certain embodiments of the invention, be implemented in the form of a computing system, an example of which is schematically shown in FIG. 5. An exemplary hardware system generally representative of such a computing system suitable for use as an encryption service appliance is shown schematically in FIG. 5. A central processing system 502 controls the hardware system 505. A central processing unit such as a microprocessor or microcontroller for executing programs is included in the central processing system 502 for the performance of data manipulations and controlling the tasks of the hardware system 505. A system bus 510 provides the communication with the central processor 502 for transferring information among the components of the hardware system 505. Facilitating information transfer between storage and other peripheral components of the hardware system may be a data channel that may be included in bus 510. Further, the set of signals required for communication with the central processing system 502 including a data bus, address bus, and control bus is provided by bus 510. It is contemplated that any state of the art bus architecture according to promulgated standards may be utilized for bus 510, for example industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on.

A main memory 504 and auxiliary memory 506 (including an auxiliary processing system 508, as required) may be provided. The storage of instructions and data for programs executing on the central processing system 502 is provided by main memory 504. Typically semiconductor-based memory such as dynamic random access memory (DRAM) and/or static random access memory (SRAM) is used for the main memory 504. However, main memory 504 may utilize other semi-conductor-based memory types, such as synchronous dynamic random access memory (SDRAM), Rambus dynamic random access memory (RDRAM), ferroelectric random access memory (FRAM), and so on. The storage of instructions and data that are loaded into the main memory 504 before execution is provided by auxiliary memory 506. The storage capabilities provided by the auxiliary memory 506 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). Alternatively, a variety of non-semiconductor-based memories, including but not limited to floppy disk, hard disk, magnetic tape, drum, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), and other varieties of memory devices as contemplated may be used for auxiliary memory 506.

Auxiliary processors of the auxiliary processing system 508, which are discrete or built into the main processor, may be included in hardware system 505. These auxiliary processors may be used as a digital signal processor (a special-purpose microprocessor having an architecture suitable for fast execution of signal processing algorithms), as a back-end processor (a slave processor subordinate to the main processing system), as an additional microprocessor or controller for dual or multiple processor systems, or as a coprocessor. They may also be used to manage input/output and/or to perform floating point mathematical operations.

A display system 512 for connecting to a display device 514, wherein the display system 512 may comprise a video display adapter having all of the components for driving the display device, including video memory, buffer, and graphics engine as desired, is included in hardware system 505. Video memory may be, for example, windows random access memory (WRAM), video random access memory (VRAM), synchronous graphics random access memory (SGRAM), and the like. The display device 514 may comprise a cathode ray-tube (CRT) type display such as a monitor or television, or an alternative type of display technology such as a projection-type CRT display, a light-emitting diode (LED) display, a gas or plasma display, an electroluminescent display, a vacuum fluorescent display, a cathodoluminescent (field emission) display, a liquid-crystal display (LCD) overhead projector display, an LCD display, a plasma-addressed liquid crystal (PALC) display, a high gain emissive display (HGED), and so forth.

An input/output (I/O) system 516 for connecting to one or more I/O devices 518, 520, and up to N number of I/O devices 522 is included in hardware system 505.

Interface functions between the one or more I/O devices 518-522 may be provided by various controllers or adapters. I/O devices such as a keyboard, mouse, trackball, touchpad, joystick, trackstick, infrared transducers, printer, modem, RF modem, bar code reader, charge-coupled device (CCD) reader, scanner, compact disc read-only memory (CD-ROM), digital versatile disc (DVD), video capture device, touch screen, stylus, electroacoustic transducer, microphone, speaker, and others may be communicatively coupled by various interface mechanisms, such as universal serial bus (USB) port, universal asynchronous receiver-transmitter (UART) port, serial port, IEEE 1394 serial bus port, infrared port, network adapter, parallel port, printer adapter, radio-frequency (RF) communications adapter, and others. Analog or digital communication capabilities between the hardware system 505 and the input/output system 516 and I/O devices 518-522 may be provided for communication with external devices, networks, or information sources. Preferably industry promulgated architecture standards are implemented by system 516 and I/O devices 518-522, including Ethernet IEEE 802 standards (e.g., IEEE 802.3 for broadband and baseband networks, IEEE 802.3z for Gigabit Ethernet, IEEE 802.4 for token passing bus networks, IEEE 802.5 for token ring networks, IEEE 802.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It is to be understood that modification or reconfiguration of the hardware system 505 of FIG. 5 by one having ordinary skill in the art would not depart from the scope or the spirit of the present invention.

Optionally, a system according to certain embodiments of the invention may be configured for scalability. More particularly, if the enterprise environment in which the encryption service appliance is to be employed requires a large number of encryption keys to be generated frequently, the key server function may be provided by way of a dedicated hardware key generation device. Moreover, load balancing may be provided by making multiple encryption service appliances active and all sharing an IP address, and mirroring each other's storage (or alternatively being connected to a storage area network). In this configuration, one primary encryption service appliance 100 may manage connection requests and forward the request to the next available encryption service appliance.

Furthermore, a failover mode of operation may be provided in which a primary encryption service appliance and one or more backup appliances are operational. If the primary encryption service appliance fails, the designated backup automatically becomes the primary. Secondary encryption service appliances may then reestablish network sessions with the new primary. When the original primary encryption service appliance 100 recovers, it may become the designated backup, and may become the primary encryption service appliance by using an administrative command.

It is believed that the present invention and many of its attendant advantages will be understood by the forgoing description. It is also believed that it will be apparent that various changes may be made in the form, construction and arrangement of the components thereof without departing from the spirit and scope of the invention or without sacrificing all of its material advantages. The form herein before described is merely an explanatory embodiment thereof.

I claim:

1. A computer implemented method for exchanging data encryption keys during an encrypted networking session without terminating the encrypted networking session, comprising:
establishing an encrypted network session between network data end points;
distributing encrypted general network session data packets through said encrypted network session; and
distributing replacement encryption keys among said network data end points during said encrypted network session and without terminating said encrypted network session, wherein said replacement encryption keys comprise general network session encryption keys and control data encryption keys that are distinct from said general network session encryption keys, and wherein said control data encryption keys are transmitted through said encrypted network session in encrypted control data packets having a data packet structure configured to simulate a data packet structure of said encrypted general network session data packets.

2. The method of claim 1, wherein said network data end points each further comprises an encryption service appliance having computer executable code stored therein that is configured to:
encrypt general network session data packets received from network operational nodes that are in direct communication with said encryption service appliance;
encrypt control data packets received from a control channel manager module of said encryption service appliance; and
transmit both of said encrypted general network session data packets and said encrypted control data packets to one or more remote encryption service appliances.

3. The method of claim 2, further comprising the step of initializing an encrypted control channel within said encrypted network session, said initialization of said encrypted control channel further comprising the steps of:
designating a first encryption service appliance as a primary encryption service appliance and designating a second encryption service appliance as a secondary encryption service appliance; and
providing said secondary encryption service appliance with a list of encryption keys and storing said list of encryption keys on said secondary encryption service appliance.

4. The method of claim 3, wherein said stored list of encryption keys further comprises general network session encryption keys and control data encryption keys that are distinct from said general network session encryption keys.

5. The method of claim 2, each of said encryption service appliances further comprising a network session encryption engine and a control channel manager module, the method further comprising the steps of:
receiving at a first network session encryption engine of a first encryption service appliance a data packet destined for a second encryption service appliance;
causing said first network session encryption engine to encrypt said data packet; and
forwarding said data packet to a second network session encryption engine of said second encryption service appliance.

6. The method of claim 5, further comprising the steps of:
receiving said data packet at said second network session encryption engine;
decrypting said data packet at said second network session encryption engine;
determining a final destination of said data packet at said second network session encryption engine; and
forwarding said data packet to said final destination.

7. The method of claim 6, wherein said data packet includes a control data packet having instructions configured to control the operation of said second encryption service appliance, further comprising the step of:
prior to encrypting said data packet at said first network session encryption engine, prepending first control data packet IP and TCP headers to said control data packet, such that said encryption of said data packet encrypts said control data packet with said first control data packet IP and TCP headers in place.

8. The method of claim 7, further comprising the step of:
encrypting at said control channel manager module said control data packet with said prepended first control data packet IP and TCP headers using one of said control data encryption keys, and thereafter prepending second control data packet IP and UDP headers to said encrypted control data packet prior to encrypting said data packet at said first network session encryption engine.

9. The method of claim 8, further comprising the steps of:
after determining a final destination of said data packet at said second network session encryption engine, removing said second control data packet IP and UDP headers from said control data packet; and
forwarding said control data packet to the control channel manager module of said second encryption service appliance.

10. The method of claim 9, further comprising the steps of:
causing said control channel manager module of said second encryption service appliance to decrypt said control data packet using one of said control data encryption keys;
removing said first control data packet IP and TCP headers from said control data packet; and
causing said control channel manager module of said second encryption service appliance to execute said instructions in said control data packet.

11. The method of claim 2, further comprising the steps of:
designating a first encryption service appliance as a primary encryption service appliance and designating a second encryption service appliance as a secondary encryption service appliance;
causing said primary encryption service appliance to designate a replacement encryption key, wherein said replacement encryption key comprises at least one of a replacement general network session encryption key and a replacement control data encryption key;
causing said primary encryption service appliance to send an encrypted Key Replacement message to said secondary encryption service appliance, wherein said Key Replacement message further comprises data identifying said replacement encryption key; and
causing said secondary encryption service appliance to replace a current encryption key used by said secondary encryption service appliance with said replacement encryption key.

12. The method of claim 11, wherein each of said encryption service appliances further comprises a network session encryption engine and a control channel manager module, the method further comprising the step of:
prior to sending said encrypted Key Replacement message to said secondary encryption service appliance, causing a first control channel manager module of said first encryption service appliance to generate an unencrypted Key Replacement message that includes the designation of said replacement encryption key, and encrypting at said first control channel manager module said unencrypted Key Replacement message using a current control data encryption key.

13. The method of claim 12, further comprising the step of:
after encrypting at said first control channel manager module said unencrypted Key Replacement message, causing said first network session encryption engine to further encrypt said Key Replacement message using a current general network session encryption key.

14. The method of claim 2, further comprising the step of:
prior to transmitting either of an encrypted general network session data packet or an encrypted control data packet from a first encryption service appliance to a remote encryption service appliance, modifying the size of said encrypted general network session data packet or said encrypted control data packet to a packet size that matches one of a limited number of available network buffer sizes.

15. The method of claim 14, wherein said number of available network buffer sizes is less than five.

16. The method of claim 15, wherein said available network buffer sizes are limited to a small buffer size having a fixed value set at 176 or fewer bytes, a medium buffer size having a fixed value set at between 176 and 640 bytes, and a large buffer size having a fixed value set at greater than 640 bytes.

17. The method of claim 14, wherein modifying the size of said encrypted general network session data packet or said encrypted control data packet further comprises adding non-zero characters to said encrypted general network session data packet or said encrypted control data packet, wherein said non-zero characters are copied from previously existing characters in the respective data packet.

18. The method of claim 2, further comprising the step of:
prior to transmitting either of an encrypted general network session data packet or an encrypted control data packet from a first encryption service appliance to a remote encryption service appliance, modifying the order of data within said encrypted general network session data packet or said encrypted control data packet to produce an order-modified data packet, and adding a mapping to said order-modified data packet providing instruction on how to reassemble said order-modified data packet to an original state.

19. A system for exchanging data encryption keys during an encrypted networking session without terminating the encrypted networking session, comprising:
a first encryption service appliance in data communication with one or more first local network operational nodes; and
a second encryption service appliance in data communication with one or more second local network operational nodes, wherein said second encryption service appliance is in data communication with said first encryption service appliance across a communications network;
wherein each of said first encryption service appliance and said second encryption service appliance have executable computer code stored thereon adapted to:
establish an encrypted network session between said first encryption service appliance and said second encryption service appliance;
distribute encrypted general network session data packets from said one or more first local network operational nodes to said one or more second network operational nodes through said encrypted network session; and
distribute replacement encryption keys among said first encryption service appliance and said second encryption service appliance during said encrypted network session and without terminating said encrypted network session, wherein said replacement encryption keys comprise general network session encryption keys and control data encryption keys that are distinct from said general network session encryption keys, and wherein said control data encryption keys are transmitted through said encrypted network session in encrypted control data packets having a data packet structure configured to simulate a data packet structure of said encrypted general network session data packets.

20. The system of claim 19, wherein said executable computer code is further adapted to:
encrypt general network session data packets received from said network operational nodes; and
encrypt control data packets received from a control channel manager module of each of said encryption service appliances.

21. The system of claim 20, wherein said first encryption service appliance is designated as a primary encryption service appliance and said second encryption service appliance is designated as a secondary encryption service appliance, and wherein said executable computer code is further adapted to:
initialize an encrypted control channel within said encrypted network session, said initialization of said encrypted control channel further comprising providing said secondary encryption service appliance with a list of encryption keys and storing said list of encryption keys on said secondary encryption service appliance.

22. The system of claim 21, wherein said stored list of encryption keys further comprises general network session encryption keys and control data encryption keys that are distinct from said general network session encryption keys.

23. The system of claim 20, wherein each of said encryption service appliances further comprises a network session encryption engine and a control channel manager module, and wherein said executable computer code is further adapted to:
receive at a first network session encryption engine of said first encryption service appliance a data packet destined for said second encryption service appliance;
cause said first network session encryption engine to encrypt said data packet; and
forward said data packet to a second network session encryption engine of said second encryption service appliance.

24. The system of claim 23, wherein said executable computer code is further adapted to:
receive said data packet at said second network session encryption engine;
decrypt said data packet at said second network session encryption engine;
determine a final destination of said data packet at said second network session encryption engine; and
forward said data packet to said final destination.

25. The system of claim 24, wherein said data packet includes a control data packet having instructions configured to control the operation of said second encryption service appliance, wherein said executable computer code is further adapted to:
prepend first control data packet IP and TCP headers to said control data packet prior to encrypting said data packet at said first network session encryption engine, such that said encryption of said data packet encrypts said control data packet with said first control data packet IP and TCP headers in place.

26. The system of claim 25, wherein said executable computer code is further adapted to:
encrypt at said control channel manager module said control data packet with said prepended first control data packet IP and TCP headers using one of said control data encryption keys, and thereafter prepend second control data packet IP and UDP headers to said encrypted control data packet prior to encrypting said data packet at said first network session encryption engine.

27. The system of claim 26, wherein said executable computer code is further adapted to:
after determining a final destination of said data packet at said second network session encryption engine, remove said second control data packet IP and UDP headers from said control data packet; and
forward said control data packet to the control channel manager module of said second encryption service appliance.

28. The system of claim 27, wherein said executable computer code is further adapted to:
cause said control channel manager module of said second encryption service appliance to decrypt said control data packet using one of said control data encryption keys;
remove said first control data packet IP and TCP headers from said control data packet; and
cause said control channel manager module of said second encryption service appliance to execute said instructions in said control data packet.

29. The system of claim 20, wherein said first encryption service appliance is designated as a primary encryption service appliance and said second encryption service appliance is designated as a secondary encryption service appliance, and wherein said executable computer code is further adapted to:
cause said primary encryption service appliance to designate a replacement encryption key, wherein said replacement encryption key comprises at least one of a replacement general network session encryption key and a replacement control data encryption key;
cause said primary encryption service appliance to send an encrypted Key Replacement message to said secondary encryption service appliance, wherein said Key Replacement message further comprises data identifying said replacement encryption key; and
cause said secondary encryption service appliance to replace a current encryption key used by said secondary encryption service appliance with said replacement encryption key.

30. The system of claim 29, wherein each of said encryption service appliances further comprises a network session encryption engine and a control channel manager module, and wherein said executable computer code is further adapted to:
prior to sending said encrypted Key Replacement message to said secondary encryption service appliance, cause a first control channel manager module of said first encryption service appliance to generate an unencrypted Key Replacement message that includes the designation of said replacement encryption key, and encrypt at said first control channel manager module said unencrypted Key Replacement message using a current control data encryption key.

31. The system of claim 30, wherein said executable computer code is further adapted to:
after encrypting at said first control channel manager module said unencrypted Key Replacement message, cause said first network session encryption engine to further encrypt said Key Replacement message using a current general network session encryption key.

32. The system of claim 20, wherein said executable computer code is further adapted to:
prior to transmitting either of an encrypted general network session data packet or an encrypted control data packet from said first encryption service appliance to said second encryption service appliance, modify the size of said encrypted general network session data packet or said encrypted control data packet to a packet size that matches one of a limited number of available network buffer sizes.

33. The system of claim 32, wherein said number of available network buffer sizes is less than five.

34. The system of claim 33, wherein said available network buffer sizes are limited to a small buffer size having a fixed value set at 176 or fewer bytes, a medium buffer size having a fixed value set at between 176 and 640 bytes, and a large buffer size having a fixed value set at greater than 640 bytes.

35. The system of claim 32, wherein modifying the size of said encrypted general network session data packet or said encrypted control data packet further comprises adding non-zero characters to said encrypted general network session data packet or said encrypted control data packet, wherein said non-zero characters are copied from previously existing characters in the respective data packet.

36. The system of claim 20, wherein said executable computer code is further adapted to:
prior to transmitting either of an encrypted general network session data packet or an encrypted control data packet from a first encryption service appliance to a remote encryption service appliance, modify the order of data within said encrypted general network session data packet or said encrypted control data packet to produce an order-modified data packet, and add a mapping to said order-modified data packet providing instruction on how to reassemble said order-modified data packet to an original state.
